(19) United States
(12) Patent Application Publication
(10) Pub. No.: US 2012/0325519 A1
(43) Pub. Date: Dec. 27, 2012

(54) WIRE PROTECTOR

(75) Inventors: Shinichi Igarashi, Yokkaichi-city (JP); Hiroaki Masuda, Yokkaichi-city (JP); Nobumasa Takihara, Yokkaichi-city (JP); Yukihiro Shirafuji, Yokkaichi-city (JP)

(73) Assignee: SUMITOMO WIRING SYSTEMS, LTD., Mie (JP)

(21) Appl. No.: 13/581,514

(22) PCT Filed: Oct. 6, 2010
(86) PCT No.: PCT/JP2010/067508

§ 371 Date: Aug. 28, 2012

(30) Foreign Application Priority Data
Apr. 9, 2010 (JP) 2010-090171

(51) Int. Cl. H01B 7/24

(52) U.S. Cl. 174/136

(57) ABSTRACT

A wire protector is provided that is lightweight, that has a simple structure, and that is capable of covering a circumference of wires along a length direction thereof and of preventing an occurrence of noise due to contact with the wires sheathed therein. The wire protector covers the circumference of the wires in the length direction thereof, is configured with a cylindrical member made of a hot press processed non-woven fabric, is formed such that an inner surface is more pliable than an outer surface hardened by the hot press process, and has a slit from the outer surface to the inner surface formed along the entire length direction.

### FIELD OF THE INVENTION

The present invention relates to a wire protector covering a circumference of wires along a length direction thereof.

### BACKGROUND OF THE INVENTION

A wire harness mounted in a vehicle, as typified by an automobile, is sought that facilitates correct wiring along a pre-determined wiring path with wires that easily acquire irregular bends (kinks), and that also does not break down due to contact of the wires with neighboring components due to vibration or the like. As such, a wire harness for vehicle mounting includes a wire protector covering a circumference of wires along a length direction thereof. In such a case, the wire protector serves to hold the wires in a shape that facilitates wiring along a predetermined wiring path in a support body such as an automobile body, and also serves to prevent the wires from breaking after contact with neighboring components.

In order to prevent a bend in the wires before the bend occurs, pre-equipping a wire harness with a comparatively hard protective tube that covers the circumference of the wires has been considered. However, in such a case, transportation and storage of the wire harness has become inconvenient. Therefore, a wire protector is preferably capable of being appended to the wires in the wire harness when the wire harness is to be attached to the support body such as the automobile body.

For example, Related Art 1 teaches a wire protector in which the wire protector is formed into a cylindrical shape covering wires in a length direction and provided with a wire insertion inlet extending in the length direction. Related Art 1 further discloses that the wire protector is a component integrally molded with a resin such as polyvinyl chloride, polyethylene, and polypropylene or a rubber-like, flexible, non-conductive material such as styrene, butadiene rubber, ethylene-propylene rubber.

Even in a case where a component such as a connector is already connected to an end of the wires when the wire harness is to be attached to the support body such as the automobile body, the wire protector taught by Related Art 1 can be appended to the wires. Even in a case where an irregular bend (kink) is formed in the wires during transportation and storage of the wire harness, the wires are simply inserted into the wire insertion inlet of the wire protector and the shape of the wires in the length direction is held in the shape of the wire protector in the length direction. Thus, by employing the wire protector taught by Related Art 1 for a wire harness, correctly wiring the wires of the wire harness along a straight-line wiring path or along a gently curving wiring path is facilitated. Moreover, the wires can be prevented from breaking after contact with neighboring components.

Meanwhile, Related Art 2 teaches a configuration in which a flat circuit body lies between two covering bodies composed of a non-woven fabric thermoplastic material and, by press-forming these components, the flat circuit body is protected while retaining a thin thickness.

### RELATED ART

### Patent Literature

Related Art 1: Japanese Patent Laid-open Publication No. H10-201044

Related Art 2: Japanese Patent Laid-open Publication No. 2003-197038

### SUMMARY OF THE INVENTION

### Problems to Be Solved by the Invention

However, the cylindrical wire protector taught by Related Art 1 has problems in which gaps are likely to occur between the inner surface of the wire protector and the wires sheathed therein, and noise is likely to occur due to the wires impacting on the inner surface of the wire protector due to vibration of the support body such as the automobile body.

In addition, in order to prevent the occurrence of the noise described above, cases have been considered in which the gap between the inner surface of the wire protector and the wires is packed with a shock-absorbing material or, alternatively, the shock-absorbing material is pre-attached to the inner surface of the wire protector. However, in such cases, there are problems such as increased costs and worker hours for manufacturing in order to add the shock-absorbing material to the wire protector.

Moreover, a wire protector mounted in a vehicle such as an automobile is sought that is more lightweight than the conventional art. Related Art 2 has no description whatever of a wire protector holding wires in a wire harness to a shape that follows a predetermined wiring path.

The present invention has as an object to provide a wire protector that is lightweight, that has a simple structure, and that is capable of covering a circumference of wires along a length direction thereof and preventing an occurrence of noise due to contact with the wires sheathed therein.

### Means for Solving the Problems

A wire protector according to the present invention covers a circumference of wires along a length direction thereof, is composed of a cylindrical member of thermoformed non-woven fabric, an inner surface is formed to be more pliable than an outer surface hardened by the thermoforming, and a slit from the outer surface to the inner surface is formed along the entire length direction.

Moreover, in the wire protector according to the present invention, the outer surface hardened by the thermoforming is preferably formed in a shape bending from an exterior to an interior at a portion on both sides of the slit along the entire length direction.

### Effect of the Invention

The wire protector according to the present invention is a cylindrical member of thermoformed non-woven fabric. The wire protector thus has a hard-formed outer surface thermoformed using a mold form and the outward form is maintained in a shape corresponding to the mold form. Even in a case where a component such as a connector is already connected to an end of wires, the wire protector can be appended to the wires by inserting the wires into an interior through a slit formed along a length direction thereof. In addition, even in a case where an irregular bend (kink) is formed in the wires during transportation and storage, the shape of the wires in the length direction is held to the shape of the wire protector in the length direction by attaching the wire protector to the wires. Accordingly, when the shape of the wire protector in the length direction is formed in a shape following the wiring path of the wires, correctly wiring the wires along the desired wiring path is facilitated. Moreover, the wires can be prevented from breaking after contact with neighboring components.

The non-woven fabric has a high heat insulating ability, and thus a temperature of an interior portion is low even when being thermoformed into a cylindrical shape. Therefore, the inner surface of the wire protector according to the present invention, which touches the wires, is in a state where flexibility derived from the non-woven fabric is maintained and thus touches the wires sheathed therein with a shock-absorbing ability. Therefore, the wire protector can prevent an occurrence of noise due to contact with the wires sheathed therein. Moreover, the wire protector is a component made of thermoformed non-woven fabric, and thus is extremely light and has excellent shock-absorbing abilities. Therefore, the wire protector is unlikely to generate noise due to contact with other components. Moreover, the wire protector is molded simply by thermoforming a non-woven fabric within a mold form, and thus can be manufactured easily and at low cost.

In the wire protector according to the present invention, when the outer surface hardened by thermoforming is formed in a shape bent from an outer side to an inner side at portions on both sides of the slit, the wires sheathed in the wire protector are unlikely to escape outward through the slit.

### BRIEF DESCRIPTION OF THE DRAWINGS

FIG. 1 is a perspective view of a wire protector 1 according to a first embodiment of the present invention.

FIG. 2 is a perspective view illustrating a state in which the wire protector is mounted on wires.

FIG. 3 is a schematic perspective view illustrating an example of a hot press apparatus used in manufacturing the wire protector 1.

FIG. 4 is a cross-sectional view of the hot press apparatus.

FIG. 5 is a view illustrating a non-woven fabric enclosure process in a manufacturing process of the wire protector 1.

FIG. 6 is a view illustrating a hot press process in the manufacturing process of the wire protector 1.

FIG. 7 is a perspective view of a cylindrical member molded by the hot press process.

FIG. 8 is a view illustrating an example of a position in which the wire protector 1 is applied in an automobile.

FIG. 9 is a perspective view of a wire protector 2 according to a second embodiment of the present invention.

FIG. 10 is a cross-sectional view illustrating a hot press process in a manufacturing process of the wire protector 2.

FIG. 11 is a plan view illustrating an example of a bottom mold form in a hot press apparatus used in manufacturing the wire protectors 1 and 2.

### MODE FOR CARRYING OUT THE INVENTION

Hereafter, embodiments of the present invention are described with reference to attached drawings. The embodiments below are examples of the present invention made concrete and are not instances limiting a technical scope of the invention. Wire protectors 1 and 2 according to embodiments of the present invention disclosed hereafter are components covering along a length direction thereof a circumference of wires in a wire harness mounted in a vehicle such as an automobile.

### First Embodiment

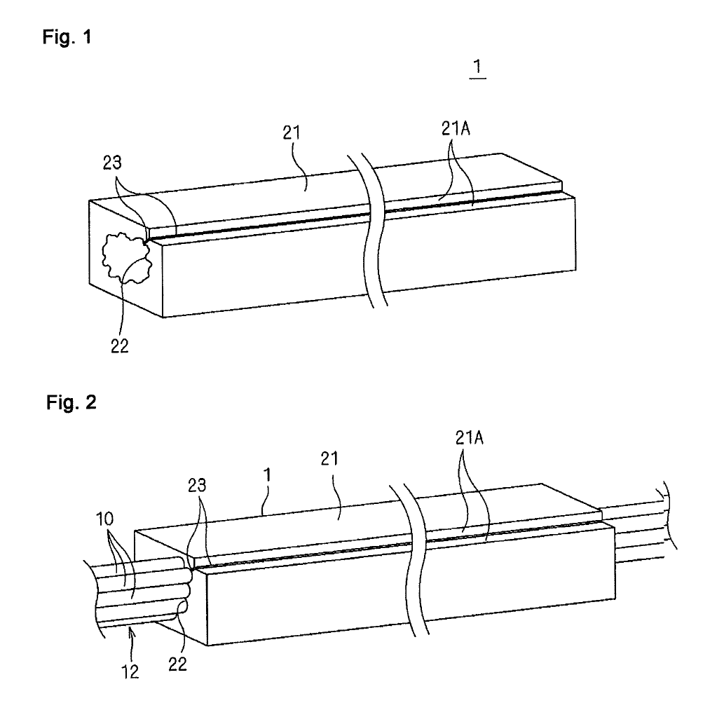

First, with reference to FIGS. 1 and 2, a configuration of the wire protector 1 according to a first embodiment of the present invention is described. FIG. 1 is a perspective view of the wire protector 1, and FIG. 2 is a perspective view illustrating a state in which the wire protector is mounted on wires.

As shown in FIGS. 1 and 2, the wire protector 1 is a cylindrical member covering along a length direction thereof a circumference of a wire bundle 12 configured with a plurality of wires 10. The wire protector 1 is also a component in which a non-woven fabric is thermoformed by a hot press process. Therefore, an outer surface 21 of the wire protector 1 is hard-formed by cooling after contact with a heated mold form during the hot press process. The outward form of the wire protector 1 is maintained in a shape corresponding to the mold form used in the hot press process. The hot press process is described hereafter.

A material of the wire protector 1 is described below. The non-woven fabric from which the wire protector 1 originates employs a non-woven fabric containing, for example, intertwining elementary fibers and an adhesive resin called a binder. The adhesive resin is a resin having a melting point lower than a melting point of the elementary fibers (for example, 110° C. to 150° C.). By heating such a non-woven fabric to a temperature lower than the melting point of the elementary fibers and higher than the melting point of the adhesive resin, the adhesive resin melts and permeates gaps in the elementary fibers. Thereafter, when the temperature of the non-woven fabric falls to a temperature lower than the melting point of the adhesive resin, the adhesive resin hardens in a state bonded to the neighboring elementary fibers. Thereby, the shape of the non-woven fabric becomes harder than a pre-heating state and maintains a shape molded by the mold form during heating.

The adhesive resin is, for example, a granular resin or a fibrous resin. A case may also be considered where the adhesive resin is formed so as to cover a circumference of a core fiber. A fiber having a structure in which a core fiber is coated with the adhesive resin in this way is referred to as a binder fiber, or the like. A material for the core fiber employs, for example, the same material as the elementary fibers.

Various kinds of fibers may be employed for the elementary fibers other than resin fibers as long as a fibrous state is maintained at the melting point of the adhesive resin. For example, a thermoplastic resin fiber having a melting point lower than the melting point of the elementary fibers is employed as the adhesive resin. A combination of the elementary fibers, which configure the non-woven fabric, and the adhesive resin may be considered which, for example, employs a resin fiber with PET (polyethylene terephthalate) as a primary component as the elementary fiber and employs a copolymer resin of PET and PEI (polyethylene isophthalate) as the adhesive resin. In the non-woven fabric of this type, the melting point of the elementary fibers is approximately 250° C. and the melting point of the adhesive resin is 110° C. to 150° C. When the non-woven fabric of this type is heated to a temperature of 110° C. to 250° C. within a mold form and then cooled, the adhesive resin melts and bonds to the neighboring elementary fibers. The non-woven fabric is thus molded to a shape following an inner surface of the mold form, and the surface in contact with the mold form hardens.

The component in which the non-woven fabric is hardened by thermoforming has a degree of flexibility; however, by being formed in a cylindrical shape, the strength to hold a shape in the length direction is reinforced. The wire protector 1 is a component molded into a cylindrical shape by heating the non-woven fabric of this type within the mold form.

In the wire protector 1 shown in FIGS. 1 and 2, a cross-section orthogonal to the length direction of the wire protector 1 is formed in a rectangular shape in which one corner is missing in a small rectangular shape. A slit 23 from an outer surface 21 to an inner surface 22 is formed at the missing portion. Moreover, in addition to the rectangular shape, cases may also be considered where the shape of the wire protector 1 in cross-section has as its basic form a circular shape, an elliptical shape, a semicircular shape, a hexagonal shape, or some other polygonal shape, and where a portion of the basic form (for example, a corner of a polygonal shape) is missing. In such a case, the slit 23 from the outer surface 21 to the inner surface 22 is formed at the missing portion of the basic form. A case may also be considered where the shape of the wire protector 1 in cross-section differs according to a position in the length direction thereof.

The slit 23 from the outer surface 21 to the inner surface 22 is formed on the wire protector 1 along the entire length direction thereof. The component formed on a wall face of the cylinder in the wire protector 1 has flexibility. Therefore, when portions 21A on both sides of the slit 23, which are formed extending in the length direction, are pushed apart, the wire protector 1 is in a half-open state. Meanwhile, when the force pushing apart the portions 21A on both sides of the slit 23 is relaxed, the wire protector 1 returns to its original cylindrical state with the slit 23 being closed. In the wire protector 1, the slit 23 acts as an inlet for inserting the wire bundle 12 to an interior of the wire protector 1.

The slit 23 acting as the inlet for the wire bundle 12 is formed on the wire protector 1, and thus even in a case where a component such as a connector is already connected to an end of the wire bundle 12, by inserting the wire bundle 12 into the interior of the wire protector 1 through the slit 23, the wire protector 1 can be appended to the wire bundle 12.

The outer surface 21 of the wire protector 1, which has been hardened by the hot press process, is formed into a shape bending from an exterior to an interior at the portions 21A on both sides of the slit 23 along the entire length direction. In the example shown in FIGS. 1 and 2, the portions 21A on both sides of the slit 23 in the outer surface 21 are formed in a shape that bends approximately 90° from the exterior to the interior.

In a case where a pressure force of the wire bundle 12 is received from within, due to the above-described shape, the portions 21A on both sides of the slit 23 have an effect of holding the slit 23 in a closed state. Therefore, the wire bundle 12 sheathed within the wire protector 1 is unlikely to escape outward through the slit 23.

Even in a case where an irregular bend (kink) is formed in the wire bundle 12 during transportation and storage, by attaching the wire protector 1 to the wire bundle 12, the shape of the wire bundle 12 in the length direction is held to the shape of the wire protector 1 in the length direction. Moreover, the portions 21A on both sides of the slit 23 in the outer surface 21 of the wire protector 1 are portions hardened by the hot press process and therefore also act as reinforcements holding the shape of the wire protector 1 in the length direction more robustly.

In the example shown in FIGS. 1 and 2, the entire wire protector 1 is formed in a straight line shape, and thus a portion of the wire bundle 12 to which the wire protector 1 is attached is held in a straight line shape. Accordingly, by being mounted on the wire bundle 12 attached along a straight-line wiring path, the wire protector 1 facilitates accurate laying of the wire bundle 12 along the straight-line wiring path.

The inner surface 22 of the cylindrical wire protector 1 has no contact with the heated mold form during the hot press process, and moreover, the non-woven fabric has a good heat insulating ability. Accordingly, a temperature of a portion inside the wire protector 1 is low even when the hot press process is performed. Therefore, the inner surface 22 of the wire protector 1 is formed to be more pliable than the outer surface 21 because a pliant state derived from the non-woven fabric is maintained. As a result, the wire protector 1 can prevent the occurrence of noise due to contact with the wire bundle 12 sheathed therein.

In addition, the wire protector 1 is a component made of thermoformed non-woven fabric, and thus is extremely light and has excellent shock-absorbing abilities. Therefore, the wire protector 1 is unlikely to generate noise due to contact with the wire bundle 12 sheathed therein and, in addition, is unlikely to generate noise due to contact with other neighboring components. Moreover, the wire protector 1 is simply molded by thermoforming the non-woven fabric within the mold form, and thus can be manufactured easily and at low cost.

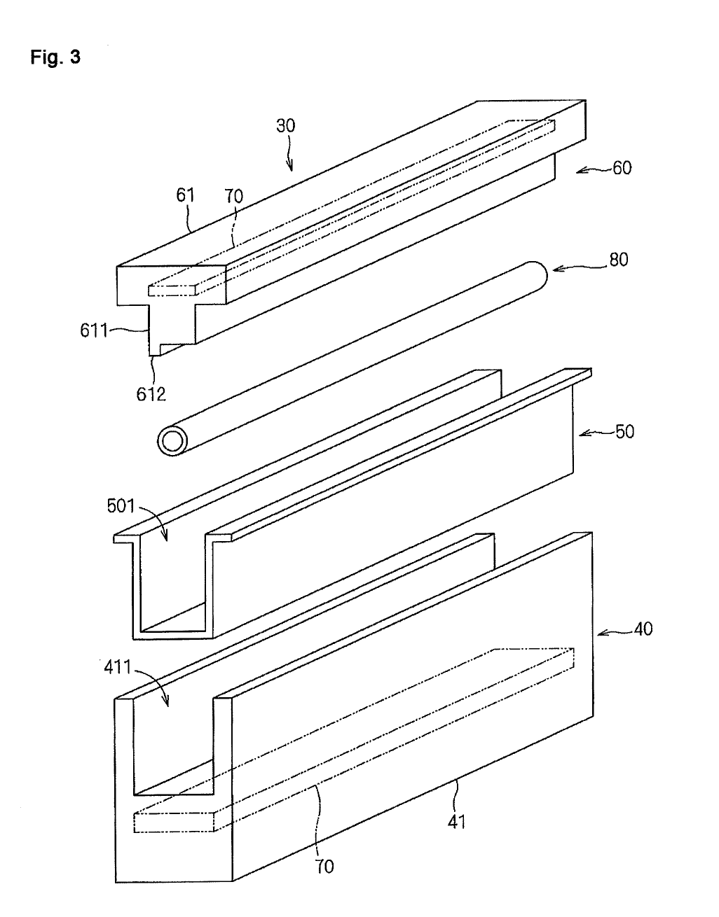

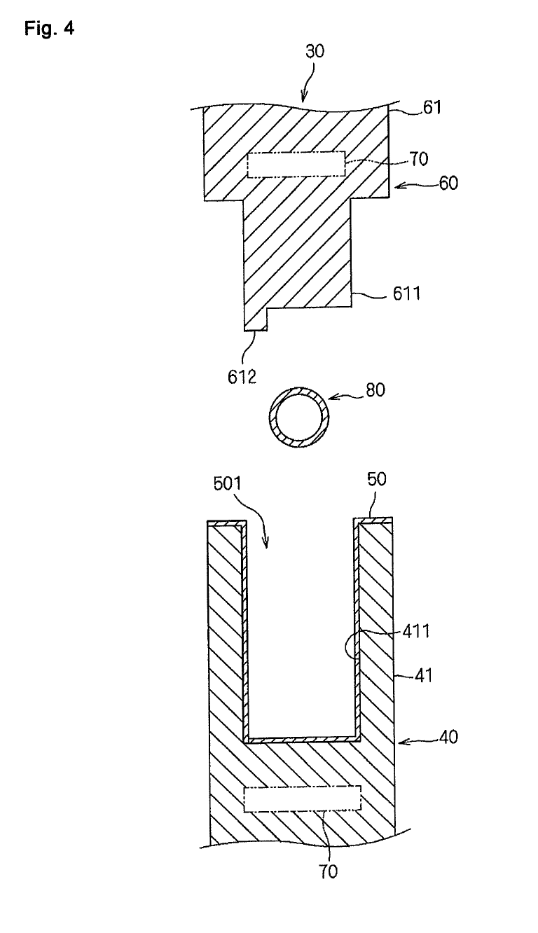

Next, with reference to FIGS. 3 and 4, an example is described of a hot press apparatus 30 used in manufacturing the wire protector 1. The hot press apparatus 30 is used in the hot press processing of the non-woven fabric. The hot press process holds the non-woven fabric for processing between metal molds and applies pressure while heating the non-woven fabric, thereby molding the non-woven fabric into a shape of inner surfaces of the metal molds.

FIG. 3 is a perspective view illustrating an example of the hot press apparatus 30 used in the hot press process of the wire protector 1. As shown in FIG. 3, the hot press apparatus 30 includes a bottom mold unit 40, a bottom mold retainer 50, a top mold unit 60, and a core member 80.

The bottom mold unit 40 includes a bottom mold member 41 and a heater 70. The bottom mold member 41 is an elongated component configured with a material such as metal having excellent thermal conductivity, and a bottom mold receiver 411 is formed on one surface (a top surface) thereof. The bottom mold receiver 411 is formed in a trench shape opening upward and at both ends in a length direction. The shape of the bottom mold receiver 411 in cross-section is rectangular.

The bottom mold retainer 50 is an elongated component configured with a material such as metal having excellent thermal conductivity, and is a component which may be detachably fitted on the bottom mold receiver 411 of the bottom mold member 41. The bottom mold retainer 50 is, for example, a component in which a metallic plate-shaped member has been processed by bending.

A bottom mold form 501 is formed on one surface (a top surface) of the bottom mold retainer 50. The bottom mold form 501 is formed in a trench shape opening upward and at both ends in a length direction. The shape of the bottom mold form 501 in cross-section is rectangular. The bottom mold form 501 in the bottom mold retainer 50 acts as a mold form shaping a lower portion during the hot press processing of the non-woven fabric from which the wire protector 1 originates.

FIG. 4 shows a state in which the bottom mold retainer 50 is mounted to the bottom mold receiver 411. The bottom surface of the bottom mold retainer 50 is formed in the same shape as the bottom mold receiver 411 of the bottom mold member 41. Thereby, when the bottom mold retainer 50 is mounted to the bottom mold receiver 411, as shown in FIG. 4, the bottom surface of the bottom mold retainer 50 engages snugly with the inner surface of the trench-shaped bottom mold receiver 411.

The bottom mold retainer 50 is a component intended to facilitate the work of placing the non-woven fabric and the core member 80 between the bottom mold unit 40 and the top mold unit 60, and the work of removing a cylindrical member molded from the non-woven fabric after the hot press process. Accordingly, the bottom mold retainer 50 is not an essential component of the hot press process and may be omitted. Moreover, in a case where the bottom mold retainer 50 is omitted, the bottom mold receiver 411 of the bottom mold member 41 acts as the mold form that shapes the lower portion during the hot press processing of the non-woven fabric from which the wire protector 1 originates.

The top mold unit 60 includes a top mold member 61 and the heater 70. The top mold member 61 is an elongated member configured with a material such as metal having excellent thermal conductivity, and a top mold form 611 is formed on one surface (a bottom surface) thereof. The top mold form 611 projects in a shape that engages with the trench portion of the bottom mold form 501 of the bottom mold retainer 50. Moreover, a projection 612 is formed on the top mold form 611 in order to shape the portions 21A on both sides of the slit 23 in the wire protector 1. The projection 612 is formed extending in the entire length direction of the top mold form 611. In the example shown in FIG. 3, the projection 612 is formed in a square columnar shape along one side surface extending in the length direction on the top mold form 611. The top mold form 611 acts as the mold form that shapes an upper portion during the hot press processing of the non-woven fabric from which the wire protector 1 originates.

A top surface shape of the bottom mold form 501 in the bottom mold retainer 50 and a bottom surface shape of the top mold form 611 in the top mold member 61 are combined to form the shape of the mold form, which is the outward shape of the wire protector 1. In the example shown in FIG. 3, the shape of the mold form is a shape where one corner in the square column is missing in the shape of a small square column. Specifically, the shape of the mold form has a square columnar shape as the basic form, and has a shape with respect to the basic form in which a trench (notch) is formed having an L-shape in cross-section that extends in the length direction. Cases may also be considered where the basic form for the shape of the mold form is some other shape, such as a round columnar shape, an elliptical columnar shape, a semicircular columnar shape, a hexagonal columnar shape, or a columnar shape of some other polygon.

The heater 70 provided to each of the bottom mold member 41 and the top mold member 61 is a heating element that heats the non-woven fabric from which the wire protector 1 originates via the bottom mold receiver 411 and the top mold form 611 to a temperature lower than the melting point of the elementary fibers and higher than the melting point of the adhesive resin. As shown in FIG. 3, a case is considered where the heater 70 is embedded in each of the bottom mold member 41 and the top mold member 61. A case may also be considered where the heater 70 is attached to an outer surface of each of the bottom mold member 41 and the top mold member 61 in a form such that heat is conductible.

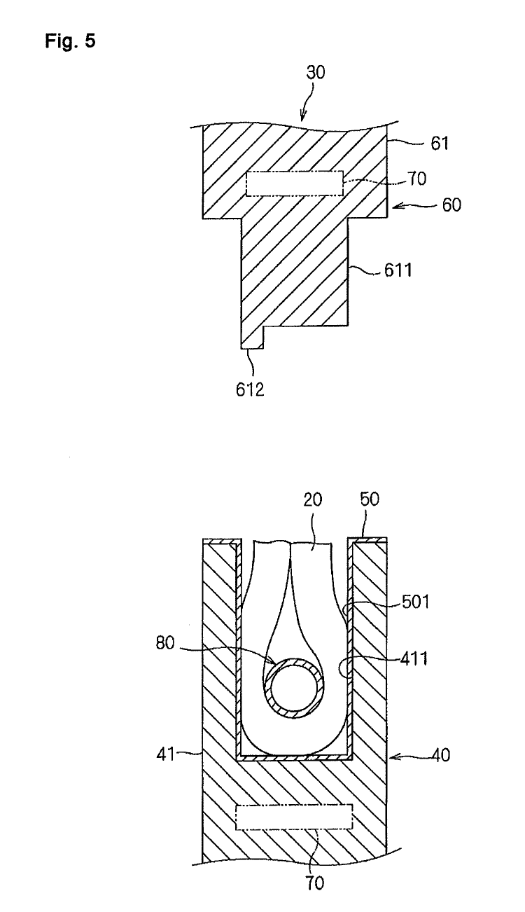

The core member 80 is a stick-like component intended to form a hollow portion inside the non-woven fabric which is molded into a cylindrical shape by the hot press process. The non-woven fabric is worked from the exterior by the hot press process in a state covering the circumference of the core member 80. The outward form of the core member 80 may have a thickness approximating a thickness of the wire bundle 12, which is to be protected by the wire protector 1. Accordingly, the core member 80 may have a cylindrical shape, i.e., a hollow stick shape, as shown in FIG. 5. The core member 80 is, for example, a resin component or a metallic component.

Next, with reference to FIGS. 5 to 7, an example of a manufacturing method of the wire protector 1 is described. In the manufacture of the wire protector 1, various steps are performed in the order of a non-woven fabric enclosure process, a hot press process, a cutting process, and a core member extraction process.

### Non-woven Fabric Enclosure Process

The non-woven fabric enclosure process is a process in which a non-woven fabric 20 covers the circumference of the core member 80 having the thickness approximating the thickness of the wire bundle 12, which is to be protected. With this process, as shown in FIG. 5, the sheet-shaped non-woven fabric 20 is disposed in a state folded in two along the inner surface of the trench-shaped bottom mold form 501, and the core member 80 is disposed in a state laid between the two folded sides of the non-woven fabric 20. The two sides of the non-woven fabric 20, which has been folded in two, are in mutual contact in a vicinity of an opening in a top portion of the bottom mold form 501.

The non-woven fabric enclosure process is, for example, a process in which the core member 80 wrapped up along a portion of the length direction by the non-woven fabric 20 is inserted into the trench-shaped bottom mold form 501 in the bottom mold retainer 50, then the bottom mold retainer 50 in which the non-woven fabric 20 and the core member 80 are inserted is mounted to the bottom mold member 41. The non-woven fabric 20 is pre-formed (cut) into a rectangular shape having a width that enables wrapping of the circumference of the core member 80.

Moreover, the non-woven fabric enclosure process may also be a process in which the core member 80, whose circumference is wrapped up by the non-woven fabric 20, is inserted into the trench-shaped bottom mold form 501 in the bottom mold retainer 50 mounted in the bottom mold member 41.

### Hot Press Process

The hot press process performed next after the non-woven fabric enclosure process is a process in which the non-woven fabric 20 covering the circumference of the core member 80 is heated within the mold form formed by the bottom mold form 501 of the bottom mold retainer 50 and the top mold form 611 of the top mold member 61, thereby molding the non-woven fabric 20 into a cylindrical member around the circumference of the core member 80.

FIG. 6 shows a state in which the non-woven fabric 20 covering the circumference of the core member 80 is heated while being compressed in the mold form formed by the bottom mold form 501 and the top mold form 611.

More specifically, in a state where the non-woven fabric 20 covering the circumference of the core member 80 has been inserted into the trench-shaped bottom mold form 501 of the bottom mold retainer 50 mounted on the bottom mold member 41, the top mold form 611 of the top mold member 61 is fitted into the bottom mold form 501. At this point, the heaters 70 in each of the bottom mold unit 40 and the top mold unit 60 are in a state where the bottom mold form 501 and the top mold form 611 are heated (an ON state). With the hot press process, the non-woven fabric 20 is heated while being compressed from the outside within the mold form in a state covering the circumference of the core member 80, and is formed into a cylindrical protective member covering the circumference of the core member 80. At this point, both sides 201 of the non-woven fabric 20 which are in mutual contact are adhered by the adhesive resin which has melted due to heating, and a cylindrical protective member is thus formed.

In the hot press process, the non-woven fabric 20 is heated by the heaters 70 to a temperature lower than the melting point of the elementary fibers contained in the non-woven fabric 20 and higher than the melting point of the adhesive resin contained in the non-woven fabric 20. The temperature and time of the heating are set as appropriate according to the hardness and flexibility sought for wire protector 1. In general, in the hot press process, the higher the heating temperature, the longer the heating time, or the higher the pressure applied, the stronger and more capable of retaining a shape a component molded from the non-woven fabric 20 is. Meanwhile, in the hot press process, the lower the heating temperature, the shorter the heating time, or the lower the pressure applied, the more pliable a component molded from the non-woven fabric is, and the more excellent the flexibility and shock-absorbing abilities of the component are.

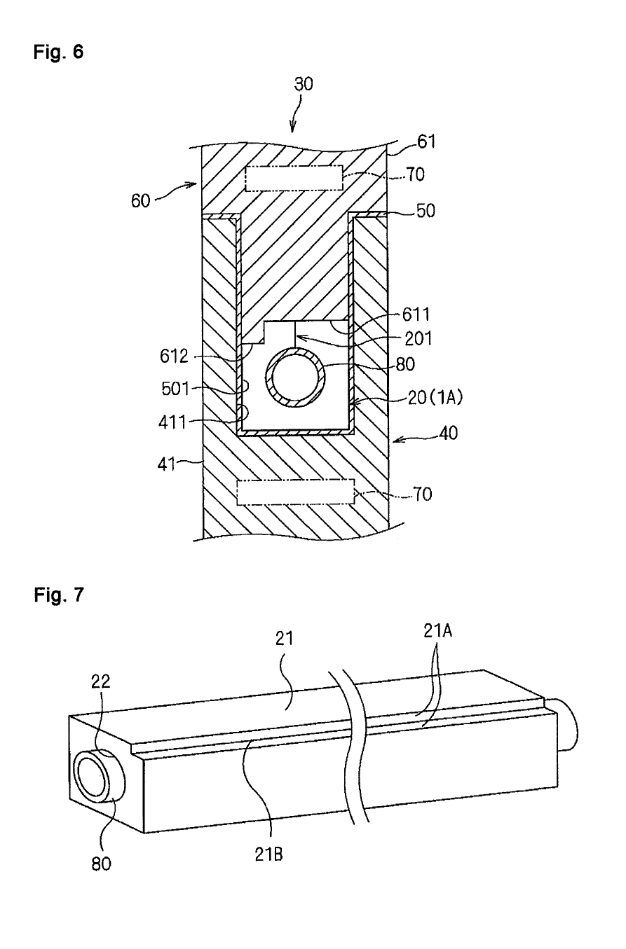

FIG. 7 is a perspective view of a cylindrical member 1A molded by the hot press process. Immediately after the hot press process, the cylindrical member 1A is in a state sheathing the core member 80. The cylindrical member 1A obtained through the hot press process is a component having an approximately straight line shape. The cylindrical member 1A is at a high temperature immediately after molding. When this temperature falls to a melting point of the adhesive resin contained in the non-woven fabric 20 or below, the outer surface 21 which was heated while in contact with the mold form hardens.

In the hot press process, the cylindrical member 1A obtained by the thermoforming is cooled by being taken out of the mold form. The cooling may be either one of a forced cooling and a natural cooling where the cylindrical member 1A is left for a predetermined time in a chamber at room temperature. Cases may be considered where the forced cooling is air cooling in which room temperature air is conveyed to the cylindrical member 1A by a fan, air cooling in which cool air output by a cooler such as a spot cooler is conveyed to the cylindrical member 1A, and the like.

The thermal insulation ability of the non-woven fabric 20 is good, and therefore a temperature of an interior portion in contact with the core member 80 is low in the hot press process, as compared to a temperature of an exterior portion in contact with the heated mold form. Accordingly, the inner surface 22 of the cylindrical member 1A is maintained at a pliable state, i.e., in a state more pliable than the outer surface 21, which is a property derived from the non-woven fabric 20.

### Cutting Process

The cutting process performed after the hot press process is a process in which the slit 23 from the outer surface 21 to the inner surface 22 is formed along the entire length direction on the cylindrical member 1A molded in the hot press process.

More specifically, in the cutting process, the cylindrical member 1A has a slit 23 from the outer surface 21 to the inner surface 22 formed by a blade such as a cutter along a center line 21B of a trench portion that has a V shape in cross-section, which is molded by the projection 612 of the top mold form 611. By going through the cutting process, the cylindrical member 1A becomes the wire protector 1.

### Core Member Extraction Process

The core member extraction process is a process in which the core member 80 is pulled out of the cylindrical member 1A which has gone through the cutting process, i.e., the wire protector 1. Moreover, the core member extraction process may also be performed next after the hot press process, and the cutting process may be performed thereafter.

As illustrated above, the wire protector 1 can be manufactured easily and at a low cost by simply covering the circumference of the core member 80 with the non-woven fabric 20, molding the non-woven fabric 20 by heating within the mold form, applying the slit 23 to the molded cylindrical member 1A, and removing the core member 80 from the cylindrical member 1A.

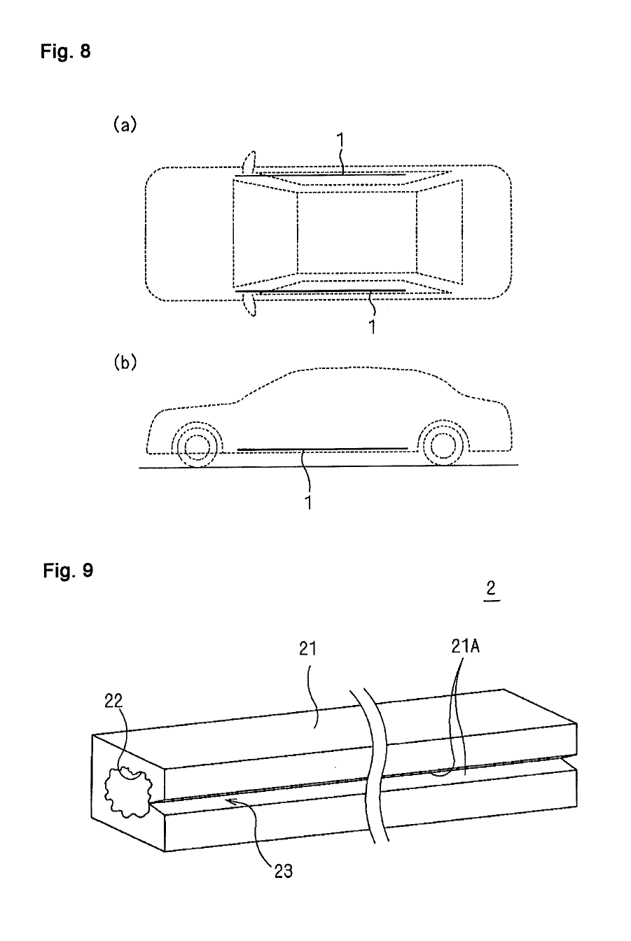

FIG. 8 is a view illustrating an example of a position at which the wire protector 1 is applied in an automobile. As shown in FIG. 8, for example, the wire protector 1 is preferably attached to the wire bundle 12 which is laid along a side sill, which is a portion of a frame configuring both sides of the vehicle body below left and right doors in the automobile.

The side sill of the automobile is a portion in which the long wire bundle 12 is laid in a straight line. Therefore, in a case where irregular bends (kinks) are formed in the wire bundle 12, the work of laying such a wire bundle 12 in a straight line along the side sill becomes extremely time-consuming. However, by attaching the wire protector 1 to the wire bundle 12 before it is laid on the side sill of the automobile, the work of laying the wire bundle in a straight line along the side sill is facilitated. Moreover, while attached to the wire protector 1, the wire bundle 12 is fixed to the side sill along with the wire protector 1 by a clamp.

When the wire protector 1 is attached along a long range in the length direction of the wire bundle 12, besides attaching one long wire protector 1 to the wire bundle 12, a case may be considered in which a plurality of wire protectors 1 are attached to the wire bundle 12 in a line.

### Second Embodiment

Next, a wire protector 2 according to a second embodiment of the present invention is described with reference to FIG. 9. The wire protector 2 has a configuration that differs from the wire protector 1 shown in FIG. 1 only in a location where the slit 23 is formed and in a shape of the portions 21A on both sides of the slit 23. In FIG. 9, structural elements that are the same as structural elements shown in FIG. 1 are given the same reference numerals. Hereafter, only those points in which the wire protector 2 differs from the wire protector 1 are described.

Similarly to the wire protector 1, the wire protector 2 is a component in which a non-woven fabric is thermoformed by a heat press process and, as shown in FIG. 9, is formed into a cylindrical shape that covers a circumference of a wire bundle along a length direction thereof.

In the example shown in FIG. 9, a cross-sectional surface orthogonal to the length direction of the wire protector 2 is formed in a shape in which an inner portion on one side of a rectangular shape is missing in a triangular shape. The missing portion forms the slit 23 from the outer surface 21 to the inner surface 22. Moreover, cases other than a rectangular shape may be considered in which the shape of the wire protector 2 in cross-section has as a basic form a circular shape, an elliptical shape, a semicircular shape, a hexagonal shape, or some other polygonal shape, and in which the shape is missing a portion (for example, an inner portion on one side of a polygonal shape) of the basic form. In such a case, the slit 23 from the outer surface 21 to the inner surface 22 is formed in the portion missing from a portion of the basic form. A case may also be considered in which the shape of the wire protector 2 in cross-section differs according to a position in the length direction thereof.

The slit 23 from the outer surface 21 to the inner surface 22 is formed on the wire protector 2 along the entire length direction of the wire protector 2. In the wire protector 2, the slit 23 acts as an inlet for inserting the wire bundle 12 into the wire protector 2, similarly to the wire protector 1.

In the wire protector 2, the outer surface 21 hardened by the hot press process is formed into a shape bending from the exterior to the interior at the portions 21A on both sides of the slit 23 along the entire length direction. In the example shown in FIG. 9, the portions 21A on both sides of the slit 23 on the outer surface 21 are formed in a shape bent at an angle less than 90° (60° to 80°) from the exterior toward the interior.

By employing the wire protector 2 shown in FIG. 9, a similar effect can be achieved as in a case employing the wire protector 1. In particular, in the wire protector 2, the portions 21A on both sides of the slit 23 hardened by the hot press process are formed in a deep trench shape reaching the inner surface 22. Therefore, the portions 21A on both sides of the slit 23 in the wire protector 2 have an excellent performance as reinforcements holding the shape of the wire protector 2 in the length direction and, in addition, have an excellent performance in preventing the wire bundle 12 from escaping to the exterior through the slit 23. An intended use of the wire protector 2 is similar to an intended use of the wire protector 1.

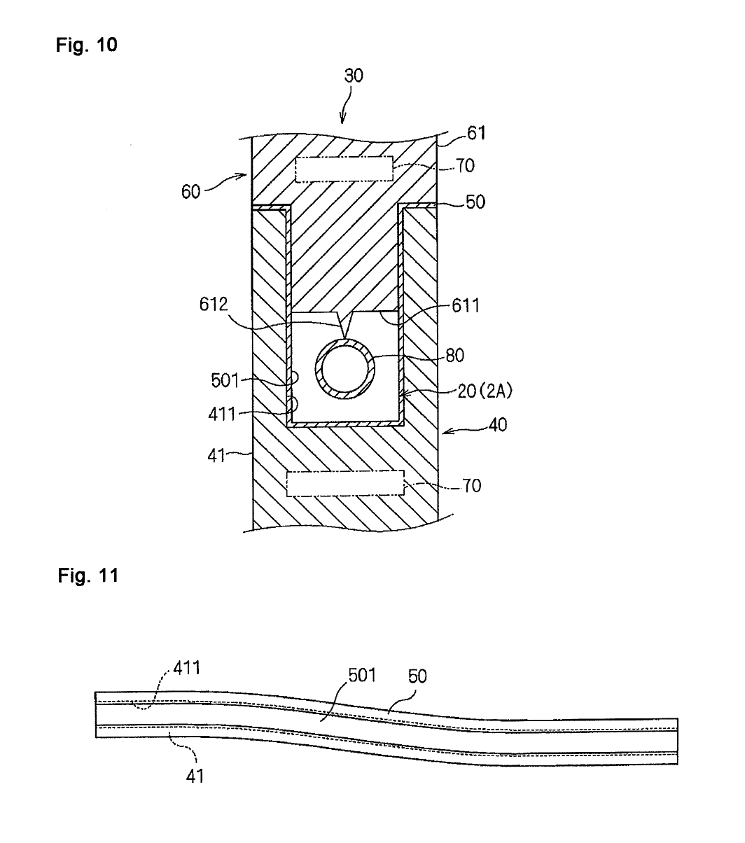

Next, a manufacturing method of the wire protector 2 is described with reference to FIG. 10. In the manufacture of the wire protector 2, various steps are performed in the order of a non-woven fabric enclosure process, a hot press process, and a core member extraction process. Specifically, the wire protector 2 is manufactured with a procedure in which the cutting process is eliminated from the procedure for manufacturing the wire protector 1. Hereafter, only those points of the manufacturing method of the wire protector 2 that differ from the manufacturing method of the wire protector 1 are described. The non-woven fabric enclosure process and the core member extraction process in the manufacture of the wire protector 2 are similar to the non-woven fabric enclosure process and the core member extraction process of the wire protector 1.

FIG. 10 is a cross-sectional view illustrating the hot press process in the manufacturing process of the wire protector 2. Specifically, FIG. 10 shows a state in which, in the hot press process, the non-woven fabric 20 covering the circumference of the core member 80 is heated while being compressed within the mold form formed by the bottom mold form 501 and the top mold form 611. With the hot press process, a cylindrical member 2A from which the wire protector 2 originates is shaped in a state where the core member 80 is sheathed therein, similar to the cylindrical member 1A shown in FIG. 7.

As shown in FIG. 10, a triangular columnar projection 612 having a height such that a forefront thereof reaches a surface of the core member 80 is formed on the top mold form 611 of the top mold member 61 used in the manufacture of the wire protector 2. The triangular columnar projection 612 is formed along a center line of a width direction (a direction orthogonal to the length direction) on the top mold form 611 and the forefront is formed with a sharp corner. In addition, in a state where the top mold form 611 is fitted into the bottom mold form 501 and the non-woven fabric 20 which covers the circumference of the core member 80 is compressed by the top mold form 611 and the bottom mold form 501, the projection 612 enters between both sides of the non-woven fabric 20 which is folded in two and forms a trench having a V shape in cross-section. In addition, the projection 612 forms the slit 23 (see FIG. 9) along a center line of the trench. Specifically, the projection 612 shapes the portions 21A on both sides of the slit 23 on the outer surface 21 of the wire protector 2 and, in addition, creates the slit 23 on the wire protector 2.

As illustrated above, the wire protector 2 can be manufactured easily and at a low cost simply by covering the circumference of the core member 80 with the non-woven fabric 20, molding the non-woven fabric 20 by heating within the mold form, and removing the core member 80 from the molded cylindrical member 1A.

The wire protectors 1 and 2 given as examples above are cylindrical components formed extending in a straight line. However, a case may be considered in which the wire protectors 1 and 2 are cylindrical components formed in a curved line.

FIG. 11 is a plan view illustrating an example of a bottom mold form (bottom mold member 41 and bottom mold retainer 50) of the hot press apparatus 30 used in the manufacture of the wire protectors 1 and 2 having a curved line shape. In FIG. 11, the bottom mold member 41 hidden beneath the bottom mold retainer 50 is shown with a dotted line.

As shown in FIG. 11, the bottom mold receiver 411 of the bottom mold member 41 and the bottom mold form 501 of the bottom mold retainer 50 are formed in a curved line along the wiring path of the wire bundle 12. In such a case, the top mold form 611 of the top mold 61 and the core member 80, neither shown in FIG. 11, are formed in a similarly curved line corresponding to the shape of the bottom mold form 501. Thereby, the wire protectors 1 and 2 having a curved line shape along the wiring path of the wire bundle 12 can be manufactured.

In the wire protectors 1 and 2 given as examples above, the outer surface 21 which is hardened by the hot press process is formed in a shape bent from the exterior to the interior at the portions 21A on both sides of the slit 23 running the entire length direction. However, in the wire protector according to the present invention, having a shape bent in this way is preferable, but is not essential. For example, in the wire protector according to the present invention, cases may be considered in which the slit 23 running the entire length direction is formed on a cylindrical component having a circular shape or a polygonal shape in cross-section and made by molding the non-woven fabric in the hot press process.

### DESCRIPTION OF REFERENCE NUMERALS

1, 2 wire protector
1A, 2A cylindrical member
10 wire
12 wire bundle
20 non-woven fabric
21 outer surface
21A portions on both sides of a slit
22 inner surface
23 slit
30 hot press apparatus
40 bottom mold unit
41 bottom mold member
50 bottom mold retainer
60 top mold unit
61 top mold member
70 heater
80 core member
201 both sides of a non-woven fabric
411 bottom mold receiver
501 bottom mold form
611 top mold form
612 projection

1. A wire protector configured to cover a circumference of wires along a length direction thereof, the wire protector comprising:
a cylindrical member formed of a thermoformed non-woven fabric, an inner surface being formed to be more pliable than an outer surface hardened by the thermoforming; and
a slit extending from the outer surface to the inner surface being formed along the entire length direction.

2. The wire protector according to claim 1, wherein the outer surface hardened by the thermoforming is formed in a shape bending from an exterior to an interior at a portion on both sides of the slit along the entire length direction.
